(19) United States
(12) Patent Application Publication
(10) Pub. No.: US 2004/0105811 A1
(43) Pub. Date: Jun. 3, 2004

(54) Preparation of aluminum water treating product

(76) Inventors: Christopher B. Lind, Flanders, NJ (US); Benjamin Shultes III, Liverpool, NY (US)

Correspondence Address: Arthur J. Plantamura, General Chemical Corp, 90 East Halsey Road, Parsippany, NJ, 07054, US

(21) Appl. No.: 10/309,303

(22) Filed: Dec. 3, 2002

(51) Int. Cl. C01F 7/02

(52) U.S. Cl. 423/626

(57) ABSTRACT

A method of making a concentrated, stable aluminum compound containing water treatment product comprising reacting an aluminum compound in solution form with a phosphoric acid compound at a temperature in the range of about 15° C. to about 98° C., measuring the aluminum as aluminum oxide content and adding water to the reaction product if needed to prepare a product having an aluminum oxide content of about 10 percent by weight of the solution. The process is particularly advantageous in providing a system for the production of aluminum water treating products by recycling aluminum waste metal such as beverage containers utilizing a phosphoric acid medium.

This invention relates to aluminum products useful in water treatment operation and to the methods for preparing such products. More particularly, the invention relates to aluminum products whose water treating properties are enhanced by a reaction of the aluminum content with a phosphorus reactant, particularly phosphoric acid.

### BACKGROUND OF THE INVENTION

Various aluminum compounds, e.g. aluminum sulfate, aluminum chloride, aluminum nitrate and the like, are used for a variety of water treatment purposes, such as to reduce turbidity, to remove color, to remove microorganisms, to reduce TOC (total organic carbon), to improve filtration, as well as to produce benefaction of waters overall. In general, the aluminum material provides a coagulant that produces a floc in the aqueous medium that helps in the removal from the water by flotation, settling out, or various modes of filtration. The removed floc includes various impurities and particles found in water, including color-forming bodies. Some examples of such aluminum products in commercial operation are: treatment of potable water; waste water processing for re-use of the water; paper treatment and sizing by paper manufacturers; processing operations in food industries, and the like. In view of the economic impact of water conservation and the increasingly stringent regulations it is highly desirable to provide a low cost and more efficiently operable product medium and reaction that can be applied in existing water treatment facilities and that produces improved results in terms of efficiently facilitating the purification and general benefaction of waters.

### SUMMARY OF INVENTION

While various methods are known for making and using additives such as aluminum sulfate, aluminum chloride and polyaluminum chloride, in the treatment of and to enhance the purity of waters derived from various sources, the present invention provides a means to utilize a variety of aluminum sources heretofore regarded as not productive in preparing additives of this type from raw materials, such as recycled aluminum. Waste aluminum metal, such as from beverage cans, foil, scrap aluminum, etc. heretofore generally regarded as not suitable for the production of water treating chemicals is effectively utilized in accordance with the invention. The aluminum metal treated with phosphoric acid yields a product having excellent performance for water treating applications.

We have discovered that a particular advantageous reaction product is obtainable from waste or recycled/recyclable aluminum materials. Utilization of the invention resides in the production of the reaction product of such disposable aluminum that is treated with a phosphorus reactant. In producing the reaction product the aluminum to be converted is preferably first treated with hydrochloric acid and then reacted with a suitable phosphorus reactant

### DETAILED DESCRIPTION OF THE INVENTION

The method of the invention involves stirring together an aluminum compound whether the dissolved metal itself or alum (aluminum sulfate), aluminum chloride or polyaluminum chloride and phosphoric acid at a temperature between 60° and 110° C., but preferably about 90° C. and about 98° C. until the aluminum metal has dissolved. The reaction product is cooled and filtered, and the aluminum content measured. The product solution based on alum can be maintained as a solution at concentrations exceeding 9% to >13% Al as Al₂O₃ in alum as compared to solutions that are not treated with a phosphorus reactant and which result in solidification at room temperature at concentration above 8.3%-805% aluminum oxide (Al₂O₃). Where appropriate for use the reaction product of the invention may be diluted with water to make a product solution suitable for intended use.

The preferred method of the invention comprises reacting the aluminum solution or slurry that has been treated with hydrochloric acid and containing from about 75 to about 94 weight percent, preferably about 85 to about 90% by weight, of aluminum compound and about 2% to about 10% of 85% by weight (commercial), of phosphoric acid. The starting materials are stirred together while maintaining suitable temperatures, and the reaction product solution is filtered. This reaction comprises a rapid, low cost method; the starting materials are inexpensive and readily available; the reaction time is generally less than four hours; and only a moderate input of external heat is required. Unexpectedly, we have also found that this product is effective at a relatively low dosage to remove turbidity. The product is accordingly highly efficient for forming floc and removing fine particles. In general, the invention provides an inexpensive product that utilizes recycled aluminum and can be used to treat water at low doses, i.e. well below about 40 ppm, resulting in a turbidity level after settling of below 2.5 NTU (Nephelometric Turbidity Units). Commercially available products of comparable effectiveness are much more expensive to produce, are not as stable, and require special handling procedures as an alternative, when aluminum chloride is employed it can be prepared in situ from hydrochloric acid and aluminum trihydrate for example.

In the preferred method, aluminum metal is treated with hydrochloric acid. The phosphoric acid is then added and the mixture is stirred for 4-8 hours and filtered through a 1-5 micron filter to remove any insoluble particles. In the reaction, the phosphoric acid is added slowly to the aluminum solution. The temperature is preferably monitored to prevent sharp increases in temperature; once the reaction is initiated any external heat source may be discontinued or reduced to a level sufficient to maintain the reaction. The phosphoric acid facilitates the dissolution and aids in keeping the temperature of the reaction mixture uniform to provide a product whose performance has superior commercial utility.

The resultant product can be used to treat all types of water, including potable and waste waters, water used in paper manufacture and sizing, and water used in the food industries and agriculture, for examples, to remove particles and color-forming bodies, to reduce turbidities and TOC and to increase filtering capacities.

After forming the aluminum reaction product solution, the aluminum oxide content is measured and the solution diluted with water if necessary to obtain an aqueous product having a basicity of from about 38.5 to about 65, and an aluminum oxide content of about 10% to 15%.

The present process is highly advantageous because its low cost starting materials produces an economical product that cleans and otherwise treats water efficiently by lowering turbidity levels at low dosage levels, and increasing filtering capacities.

The invention will be further described in the following examples; however, the invention is not meant to be limited to the details described therein.

### EXAMPLE 1

Reagents

1. 114.4 grams Concentrated Hydrochloric Acid

2. 260.1 grams Water

3. 35 grams used aluminum metal container that comprises shredded aluminum cans

4. 30 grams 85% phosphoric acid

5. 60.5 grams Water

Sequence of Method Steps

1. The Concentrated HCl (114.4 g) and initial quantity (260.6 g) of de-ionized water are introduced into a suitable reaction vessel

2. The acid/water solution is heated to 90° C.

3. The aluminum metal (35 grams) is added and the temperature maintained at 95° C. for about 2.0 to 2.5 hours or until the reaction mixture is clear, i.e., until all aluminum metal is dissolved

4. To this solution 30 grams of phosphoric acid and the balance (62.5 g) of the de-ionized water are added and the reaction is continued at approximately 80° C. for about 45 minutes. Note that if there is significant reaction of the phosphoric acid with the initial solution, such as evolution of hydrogen (bubbles) or an increase in reaction temperature, suspend the further addition of phosphoric acid and allow the aluminum solution to continue reaction with HCl. Addition of the rest of H₃PO₄ may resume after the reaction subsides.

5. Cool and, if necessary, filter

The reaction product characteristics are as follows:

pH 2.4

Aluminum 13.1% as Al₂O₃ (Target 11%)

Basicity 55% (Target 55%)

Specific Gravity 1.232

Clear to slightly yellow solution

The following aluminum sources have been successfully used with the above described procedure:

Aluminum cans, tops removed, shredded

Aluminum hydroxide

Aluminum shot<10 mm diameter

Aluminum shot, recycled 3-15 mm diameter

Although phosphoric acid is the preferred phosphoric reactant a variety of other phosphorus providing reactants such as sodium phosphate, monobasic (NaH₂PO₄*nH₂O;n≧0), sodium phosphate, tribasic Na₃PO₄*nH₂O;n≧0), sodium phosphate dibasic Na₂HPO₄*nH₂O;n>0), calcium phosphate, (Ca₃(PO₄))₂*nH₂O;n>0), (CaHPO₄*nH₂O;n>0) and the like. Mono basic, dibasic and tribasic potassium phosphates may also be suitably utilized.

### EXAMPLE 2a, 2b, 2c and 2d

Reagents

The following describes the aluminum sulfate preparation for each example:

1. 100 grams Aluminum trihydrate plus additional of 15 or 20 grams as described below for the individual examples. Appropriate amounts of bauxite or other aluminum source that provides an equivalent Aluminum content may be substituted.

2. 110 grams water

3. 200-210 grams of 93% sulfuric acid, or equivalent dosage of weaker or stronger acid, adjusting the quantity of water with weaker acids

4. Sufficient water to maintain a suitable volume and to adjust to the appropriate acid strength at end of reaction

Phosphoric Acid/Phosphate Additions

### EXAMPLE 2a

15 grams additional aluminum trihydrate were used plus 15 grams of phosphoric acid plus sufficient water to adjust for the appropriate strength at the end of the reaction.

### EXAMPLE 2b

15 grams additional aluminum trihydrate were used plus 50 grams of phosphoric acid and sufficient water to adjust to the appropriate strength at the end of the reaction.

### EXAMPLE 2c

15 grams additional aluminum trihydrate were used plus 75 grams phosphoric acid and sufficient water to adjust to the appropriate strength at the end of the reaction.

### EXAMPLE 2d

15 grams additional aluminum trihydrate were used plus 150 grams phosphoric acid and sufficient water to adjust for the appropriate acidity strength at end of reaction.

See Phosphate source notes in example 1 for variations

Procedure

1. Sulfuric acid is added to initial charge of water

2. Aluminum trihydrate (115 to 120 grams) is added slowly and allowed to react for 2-2.5 hours with continuous mixing

3. Water is added to keep volume to at least 300 ml

4. At the end of reaction, phosphoric acid is added in amounts as specified above for each of examples 2a, 2b, 2c, 2d and mixing is continued for up to about one hour

5. Sufficient water is added to adjust to the desired and the product is cooled and filtered if necessary.

The following comprise the product characteristics

pH 2-3

Aluminum content 9-11% as Al₂O₃

Specific Gravity 1.2-1.35

Clear to slightly yellow appearance

### EXAMPLE 3

463g AlCl₃ aluminum chloride

148.5 g DIH₂O deionized water

20.8 g of aluminum shot having a 3-15 mm size obtained from Pilgrim Recycling

632.3 g total reagents

The components are mixed and react @ 106-110° C. for 6 hours minimum

The reaction product had the analysis set forth in Table I

TABLE I

| | |
|---|---|
| % Al₂O₃ | 15.61 |
| % basicity | 49.88 |
| pH | 1.64 |
| Jar test | Passes |
| Specific gravity | 1.305 |

### EXAMPLE 4

The following ingredients and order of additives were used:

114.5 g conc HCl

260.6 g of deionized water

35 g of aluminum shot (obtained from Reynolds metals Co. −6+20 lot #426999)

30 g phosphoric acid

62.5 g of deionized water

502.6 g

Procedure

1. Add HCl and initial quantity (260.6 g) of deionized water to the reactor and heat to 90° C.

2. Add the aluminum and react the mixture at 95° C. for about 2.5 hours or until a clear color is present. Then add the H₃PO₄-H₂O mix and then react @ 85° C. for 1 hour. Cool, remove and filter.

The results are set forth in TABLE II.

TABLE II

| | |
|---|---|
| % Al₂O₃ | 13.94 |
| % basicity 61.13% | 61.13 |
| PH | 2.83 |
| S.G. | 1.257 |

### EXAMPLE 5

The following ingredients and order of addition were used:

114.5 g conc HCl

235 g deionized water

60 g aluminum shot (Reynolds −6+20)

30 g phosphoric acid and

362.5 g of deionized water

602 g total reagents

Procedure

1. Add HCl and initial H₂O to a suitable reactor, and heat to 90° C.

2. Introduce the aluminum shot and react @95° C. for about 2.5 hours or until clear, then add H₃PO₄/H₂O mix and react @ 80° C. for 1 hour. The product is the removed and filtered and the properties shown in TABLE III.

TABLE III

| | |
|---|---|
| Al₂O₃ | 22.7 |
| Basicity | 73.1 |
| 1.389 | 1.389 |

### EXAMPLE 6

Ingredients:

420 g AlCl₃ aluminum chloride (GenPac1000 obtained from GenTek Inc)

145 g deionized water

42 g aluminum trihydrate

607 g total ingredients

Procedure

1. Add AlCl₃ and 50 g of the deionized water to a suitable reactor and heat to 100° C.

2. Then mix the remaining H₂O (95 g) with the trihydrate introduce into the reactor and react at 115° C. for 6 hours.

The product characteristics are shown in TABLE IV.

TABLE IV

| | |
|---|---|
| % Al₂O₃ | 12.73% |
| % basicity | 20.29% |
| pH | 0.20 |
| S.G. | 1.312 |

### EXAMPLE 7

Ingredients:

430 g AlCl₃

148.5 g deionized water

20.8 g aluminum shot (Reynolds metals Co.) −6+20 lot #42-6999

599.3 g total ingredients

Procedure:

1. The ingredients were introduced and mixed in a suitable reaction vessel at 105-106° C. for 6 hours minimum.

The product characteristics are shown in TABLE V.

TABLE V

| | |
|---|---|
| Al₂O₃ | 15.32 |
| % basicity | 49.72 |
| pH | 1.67 |
| Jar test | Passes |
| Specific gravity | 1.301 |

### EXAMPLE 8

Ingredients:

420 g AlCl₃

100 g deionized water

40 g aluminum trihydrate

560 g total ingredients

Procedure:

1. The aluminum chloride is added to a suitable reactor and heated to 110° C.;

2. Then add the 40 g hydrate/with the 100 g deionized water to the reactor; and

3. Continue the reaction at 115° C. for 6 hours.

The product properties are set forth in TABLE VI.

TABLE VI

| | |
|---|---|
| Al₂O₃ | 14.33 |
| Basicity | 28.4 |
| S.G. | 1.32 |
| pH | 0.01 |

### EXAMPLE 9

Ingredients:

420 g AlCl₃ (GenPac 1000)

145 g deionized water

42 g aluminum trihydrate

12 g aluminum powder (obtained from Fisher Scientific)

619 g total weight of ingredients

Procedure:

1. The aluminum chloride and 50 g of the deionized water are introduced to a suitable vessel and heated to 110° C.

2. The water and trihydrate mix of 95 g of deionized water and 42 g aluminum trihydrate are mixed and added to the reactor and heated. Heating is continued at 135° C. for 5-6 hours.

3. The aluminum powder is introduced into the reactor slowly over a period of about 4 hours while observing the reactive temperature and controlling excessive H₂ generation and bubbles with a dI water spray.

The product properties are set forth in TABLE VII.

TABLE VII

| | |
|---|---|
| % Al₂O₃ | 14.96 |
| % Basicity | 24.33 |
| pH | 0.12 |
| S.G. | 1.349 |

Although the invention has been described in terms of particular embodiments, blends of one or more of the various additives described herein can be used, substitutes therefor, as will be known to those skilled in the art. Thus the invention is not meant to be limited to the details described herein, but only by the scope of the appended claims.

What is claimed:

1. A method of producing an aluminum water treatment product comprising:
a) dissolving an aluminum compound by liquefying a solid aluminum compound in an acid medium at a temperature of about 20° C. to about 125° C.,
b) reacting the aluminum reaction solution with from about 1 to about 10 weight percent of a phosphorus compound; and
c) diluting the resultant reaction product with water to make a product solution containing about 23% by weight of aluminum as aluminum oxide (Al₂O₃) and having a basicity of from about 30 to 85 percent.

2. A method according to claim 1 wherein said phosphorus compound is phosphoric acid (85% phosphoric acid)

3. A method according to claim 1 wherein said aluminum compound comprises recycled aluminum.

4. A method according to claim 3 wherein said recycled aluminum are beverage containers.

5. A method according to claim 2 wherein the phosphorus compound is phosphoric acid.

6. The method according to claim 1 wherein the acid medium comprises hydrochloric acid.

7. The method according to claim 1 wherein the acid medium comprises sulfuric acid.

8. The method of claim 2 wherein the acid medium is hydrochloric acid.

9. The method of claim 2 wherein the acid medium is sulfuric acid.

10. The method of claim 6 wherein the aluminum compound is aluminum metal.

11. The method of claim 1 wherein the aluminum compound is recycled or recovered aluminum hydroxide.

12. The method of claim 7 wherein the acid medium an aluminum compound are supplied by aluminum sulfate.

13. The method of claim 1 wherein aluminum sulfate, liquid comprise is the dissolve aluminum compound of step (a).
